(19) United States
(12) Patent Application Publication
(10) Pub. No.: US 2024/0107160 A1
(43) Pub. Date: Mar. 28, 2024

(54) PERCEPTION MODES

(71) Applicant: Apple Inc., Cupertino, CA (US)

(72) Inventors: Varun K. PENDHARKAR, Los Gatos, CA (US); Onur E. TACKIN, Saratoga, CA (US); Dhruv SAMANT, Mountain View, CA (US); Mahmut DEMIR, Dublin, CA (US); Samuel D. POST, Great Falls, MT (US); Nathan M. PACZAN, Kirkland, WA (US); David A. ANTLER, Seattle, WA (US); Johnnie B. MANZARI, San Francisco, CA (US)

(21) Appl. No.: 18/370,348

(22) Filed: Sep. 19, 2023

Related U.S. Application Data
(60) Provisional application No. 63/409,508, filed on Sep. 23, 2022.

(51) Int. Cl. H04N 23/667; H04N 23/23; H04N 23/63; H04N 23/695

(52) U.S. Cl. CPC H04N 23/667; H04N 23/23; H04N 23/631; H04N 23/695

(57) ABSTRACT

Some techniques are described herein for providing different modes, each mode allowing for a different sensor to detect data. For example, a first mode can be configured to detect data via a touch sensor, a second mode can be configured to detect data via an infrared camera, and a third mode can be configured to detect data via an optical camera. In such an example, different modes can be configured to detect data using a different set of sensors that are in communication with a computer system.

### CROSS REFERENCE TO RELATED APPLICATIONS

This application claims benefit of U.S. Patent Application No. 63/409,508, entitled “PERCEPTION MODES,” filed on Sep. 23, 2022, which is hereby incorporated by reference herein in its entirety for all purposes.

### BACKGROUND

Today, computer systems often have different sensors for detecting sensor data in a physical environment. For example, a computer system can include a camera that captures images and a touch-sensitive display that detects touch inputs. Such sensors reveal a different amount of information about a physical environment, and sometimes not all of this information is needed. Accordingly, there is a need to improve sensor data detection on a computer system.

### SUMMARY

Current techniques for detecting sensor data in a physical environment are generally ineffective and/or inefficient. For example, some techniques are intrusive to a user and unnecessarily detect data that is not needed or wanted. This disclosure provides more effective and/or efficient techniques for detecting sensor data in a physical environment using an example of a computer system with a touch screen, an infrared camera, and an optical camera. It should be recognized that other types of sensors can be used with techniques described herein. For example, a computer system can include a temperature sensor and a heart rate sensor, where the computer system can selectively use the temperature sensor to detect data or the heart rate sensor to detect data based on a mode of the computer system. In addition, techniques optionally complement or replace other techniques for detecting faults in physical components.

Some techniques are described herein for providing different modes (e.g., operational and/or perception modes), each mode allowing for a different set of one or more sensors to detect data. For example, a first mode can be configured to detect data via a touch sensor, a second mode can be configured to detect data via an infrared camera, and a third mode can be configured to detect data via an optical camera. In such an example, different modes can be configured to not detect data via one or more particular sensors, such as the first mode can be configured to not detect data via one or more cameras (e.g., the infrared camera and/or the optical camera), the second mode can be configured to not detect data via the optical camera, and the third mode can be unrestricted in which sensors can be used to detect data.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system.

FIG. 2 is a block diagram illustrating a device with interconnected subsystems.

FIG. 3A is a block diagram illustrating a mounted device operating in a night mode.

FIG. 3B is a block diagram illustrating a mounted device operating in a night mode with a user moving to a different location.

FIG. 3C is a block diagram illustrating a mounted device operating in a day mode.

FIG. 3D is a block diagram illustrating a mounted device operating in a day mode with a user moving to a different location.

FIG. 3E is a block diagram illustrating a mounted device operating in an active mode.

FIG. 3F is a block diagram illustrating a mounted device operating in an active mode with a user moving to a different location.

FIG. 4 is a flow diagram illustrating a method for detecting data using different sensors.

### DETAILED DESCRIPTION

The following description sets forth exemplary techniques, methods, parameters, systems, computer-readable storage mediums, and the like. It should be recognized, however, that such description is not intended as a limitation on the scope of the present disclosure. Instead, such description is provided as a description of exemplary embodiments.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described embodiments. In some examples, the first subsystem and the second subsystem are two separate references to the same subsystem. In some embodiments, the first subsystem and the second subsystem are both subsystem, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

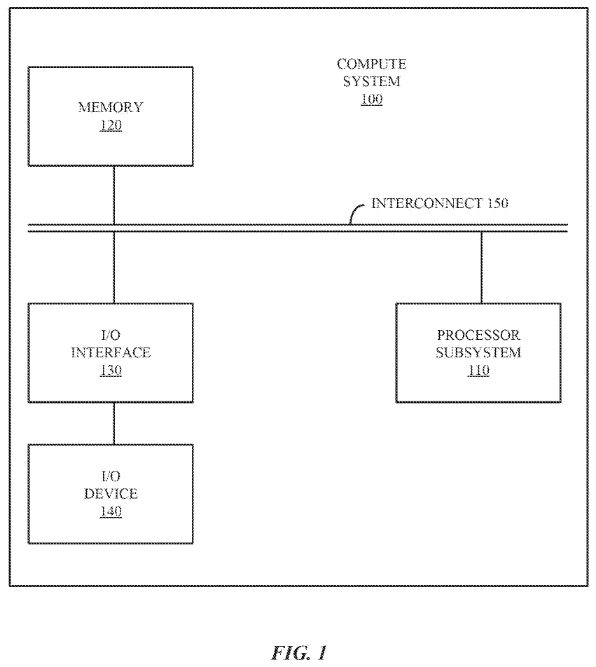

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 coupled (e.g., wired or wirelessly) to memory 120 (e.g., a system memory) and I/O interface 130 via interconnect 150 (e.g., a system bus, one or more memory locations, or other communication channel for connecting multiple components of compute system 100). In addition, I/O interface 130 is coupled (e.g., wired or wirelessly) to I/O device 140. In some examples, I/O interface 130 is included with I/O device 140 such that the two are a single component. It should be recognized that there can be one or more I/O interfaces, with each I/O interface coupled to one or more I/O devices. In some examples, multiple instances of processor subsystem 110 can be coupled to interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some examples, compute system 100 is included with or coupled to a physical component for the purpose of modifying the physical component in response to an instruction. In some examples, compute system 100 receives an instruction to modify a physical component and, in response to the instruction, causes the physical component to be modified. In some examples, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some examples, a sensor includes one or more hardware components that detect information about a physical environment in proximity to (e.g., surrounding) the sensor. In some examples, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some examples, a sensor includes a combination of multiple sensors. In some examples, sensor data is captured by fusing data from one sensor with data from one or more other sensors. Although a single compute system is shown in FIG. 1, compute system 100 can also be implemented as two or more compute systems operating together.

In some examples, processor subsystem 110 includes one or more processors or processing units configured to execute program instructions to perform functionality described herein. For example, processor subsystem 110 can execute an operating system, a middleware system, one or more applications, or any combination thereof.

In some examples, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some examples, the operating system includes various procedures, sets of instructions, software components, and/or drivers for controlling and managing general system tasks (e.g., memory management, storage device control, power management, or the like) and for facilitating communication between various hardware and software components. In some examples, the operating system uses a priority-based scheduler that assigns a priority to different tasks that processor subsystem 110 can execute. In such examples, the priority assigned to a task is used to identify a next task to execute. In some examples, the priority-based scheduler identifies a next task to execute when a previous task finishes executing. In some examples, the highest priority task runs to completion unless another higher priority task is made ready.

In some examples, the middleware system provides one or more services and/or capabilities to applications (e.g., the one or more applications running on processor subsystem 110) outside of what the operating system offers (e.g., data management, application services, messaging, authentication, API management, or the like). In some examples, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some examples, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some examples, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some examples, the first node notifies the second node that the data has been stored in the memory by sending a pointer (e.g., a memory pointer, such as an identification of a memory location) to the second node so that the second node can access the data from where the first node stored the data. In some examples, the first node would send the data directly to the second node so that the second node would not need to access a memory based on data received from the first node.

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 800, 900, 1000, 11000, 12000, 1300, 1400, and 1500 described below.

Memory 120 can be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some examples, these other forms of storage can also store program instructions executable by processor subsystem 110 to perform operations described herein. In some examples, processor subsystem 110 (or each processor within processor subsystem 110) contains a cache or other form of on-board memory.

I/O interface 130 can be any of various types of interfaces configured to couple to and communicate with other devices. In some examples, I/O interface 130 includes a bridge chip (e.g., Southbridge) from a front-side bus to one or more back-side buses. I/O interface 130 can be coupled to one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some examples, compute system 100 is coupled to a network via a network interface device (e.g., configured to communicate over Wi-Fi, Bluetooth, Ethernet, or the like). In some examples, compute system 100 is directly or wired to the network.

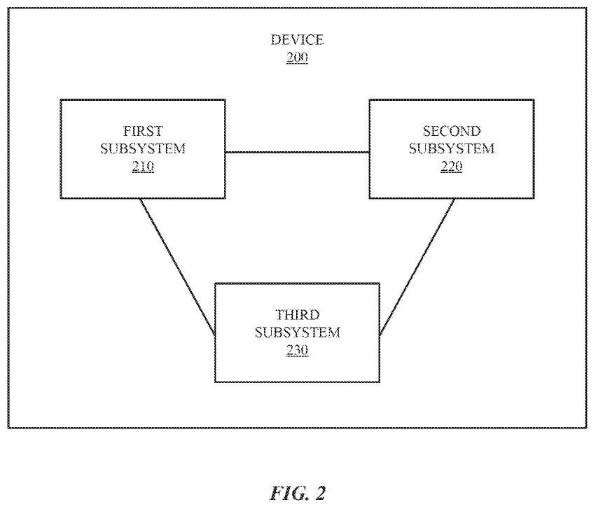

FIG. 2 illustrates a block diagram of device 200 with interconnected subsystems. In the illustrated example, device 200 includes three different subsystems (i.e., first subsystem 210, second subsystem 220, and third subsystem 230) coupled (e.g., wired or wirelessly) to each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some examples, some subsystems are not connected to other subsystem (e.g., first subsystem 210 can be connected to second subsystem 220 and third subsystem 230 but second subsystem 220 cannot be connected to third subsystem 230). In some examples, some subsystems are connected via one or more wires while other subsystems are wirelessly connected. In some examples, messages are set between the first subsystem 210, second subsystem 220, and third subsystem 230, such that when a respective subsystem sends a message the other subsystems receive the message (e.g., via a wire and/or a bus). In some examples, one or more subsystems are wirelessly connected to one or more compute systems outside of device 200, such as a server system. In such examples, the subsystem can be configured to communicate wirelessly to the one or more compute systems outside of device 200.

In some examples, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some examples, device 200 is configured to navigate (with or without user input) in a physical environment.

In some examples, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some examples, at least a portion of device 200 functions as a distributed compute system. For example, a task can be split into different portions, where a first portion is executed by first subsystem 210 and a second portion is executed by second subsystem 220.

Attention is now directed towards techniques for detecting sensor data in a physical environment. Such techniques are described in the context of a computer system with a touch screen, an infrared camera, and an optical camera. It should be recognized that other types of sensors can be used with techniques described herein. For example, a computer system can include a motion sensor and a radar sensor, where one or more of these sensors are optionally configured to detect data based on a current mode. In addition, techniques optionally complement or replace other techniques for detecting sensor data in a physical environment.

Some techniques are described herein for providing different modes, each mode allowing for a different sensor to detect data. For example, a first mode (referred to as night mode) can be configured to detect data via a touch sensor, a second mode (referred to as day mode) can be configured to detect data via an infrared camera, and a third mode (referred to as active mode) can be configured to detect data via an optical camera. In such an example, different modes can be configured to not detect data via particular sensors, such as the night mode can be configured to not detect data via cameras (e.g., the infrared camera and/or the optical camera) and the day mode can be configured to not detect data via the optical camera.

In some examples, different modes are used to detect a user, such that the different sensors mentioned above are attempting to detect a user and, when detecting the user, performing one or more operations related to the user. Such operations can include following the user so that the user can see what is being displayed on a device and/or changing to a different mode to output content to be viewed by the user. For example, the day mode can be configured to detect the user in a general area of a physical environment and ensure that a display of the device is facing the general area while the active mode is configured to track the user with higher resolution and ensure that a display of the device is directly facing the user.

In some examples, different modes are configured to move a different amount. For example, the night mode can be configured not to move, the day mode can be configured to move more than the night mode, and the active mode can be configured to move more than the day mode.

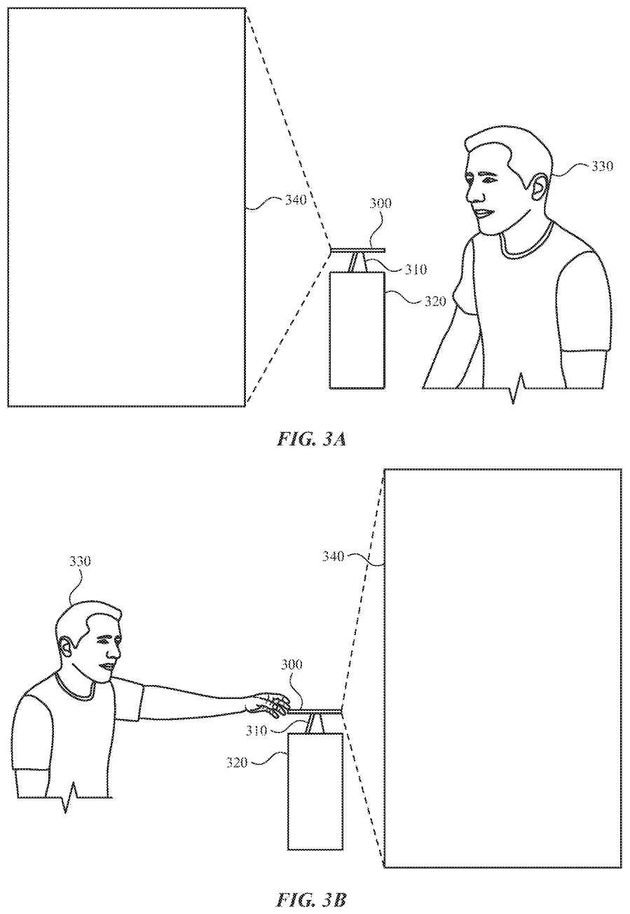

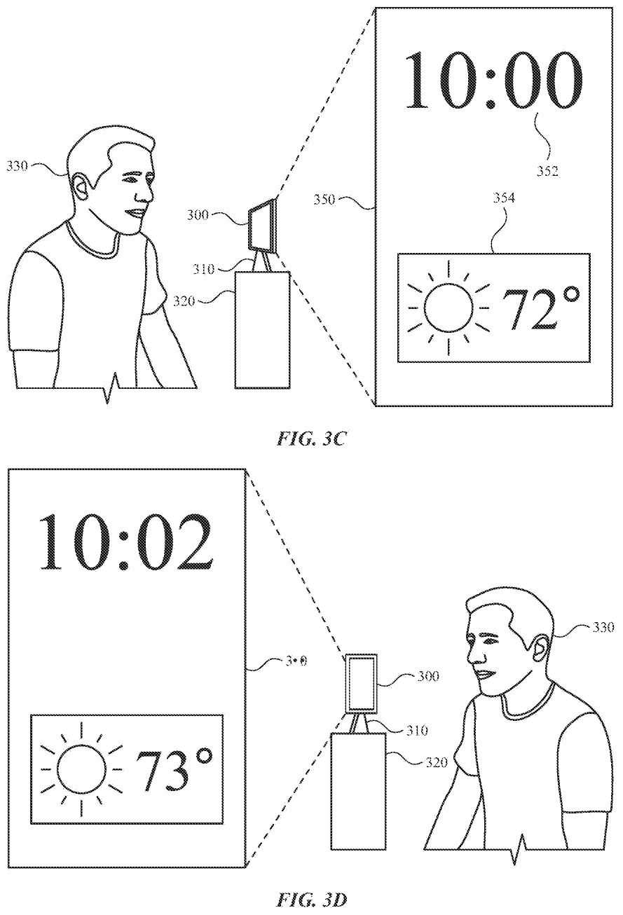

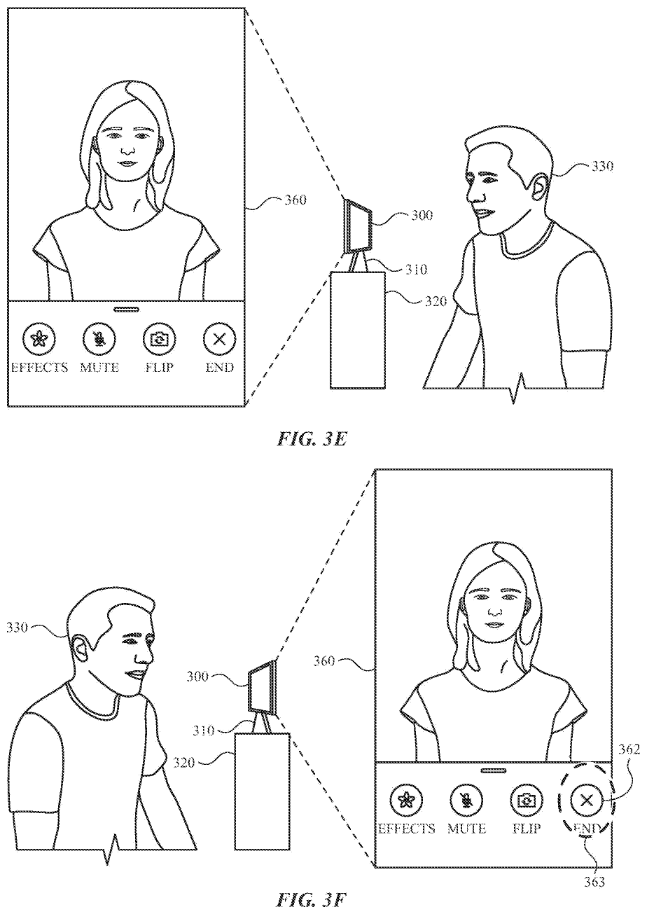

FIGS. 3A-3F illustrate an example of mounted device 300 operating in three different modes: a night mode (e.g., a first mode, such as a low-power mode, a low-perception mode, or high-privacy mode), a day mode (e.g., a second node, such as a medium-power mode, a medium-perception mode, or an average-privacy mode), and an active mode (e.g., a third node, such as a high-power mode, a high-perception mode, or a reduced-privacy mode). The different modes configure mounted device 300 to function differently, including allowing different sensors to operate in different modes, sending instructions to move mount 310, and displaying different content as further discussed below.

In some examples, mounted device 300 is an electronic device (and/or a computer system), such as a smartphone, smartwatch, tablet, laptop, desktop, or projector. In some examples, mounted device 300 is configured to display content. In some examples, mount 310 is an electronic device, such as a motorized device that is configured to physically move (e.g., orient) a device (e.g., mounted device 300) coupled to mount 310. It should be recognized that mounted device 300 and/or mount 310 can include more or fewer components, such as components described above with respect to FIGS. 1 and 2.

As illustrated, mounted device 300 is coupled (e.g., temporarily coupled such that electronic device can disengage the coupling) to mount 310 and mount 310 is sitting on stand 320. In some examples, mount device 300 is temporarily coupled via a wire, a magnet, a connector (e.g., a plug and/or a USB connector), a physical structure, or any other physical mechanism for attaching or securing one device to another.

In some examples, mounted device 300 is configured to communicate with mount 310. For example, a secure communication can be established between mounted device 300 and mount 310 and can be initiated by either device. In such examples, the secure communication is used to communicate instructions from mounted device 300 to mount 310. Such instructions can include to start or stop charging by mount 310, to lock mount 310 in a particular position, and/or to have mount turn, move, or otherwise change location or orientation of mount 310. In some examples, movement by mount 310 is with respect to location and/or orientation. For example, mounted device 300 can move mount 310 to ensure that mounted device 300 is facing an appropriate direction during operation, whether the appropriate direction be toward or away from a user, toward or away from an object in a physical environment, and/or toward or away from a particular direction.

FIG. 3A is a block diagram illustrating mounted device 300 operating in a night mode. In some examples, the night mode is a standby or off mode in which a user (e.g., user 330) is not interacting with mounted device 300. In such examples, the night mode is a mode in which user 330 does not want mounted device 300 to be facing user 330 and/or is in a position capable of capturing certain data related to user 330.

In some examples, a current mode determines what is displayed by mounted device 300. For example, the night mode can cause mounted device 300 to not display anything, as depicted by user interface 340. In such an example, a display generation component of mounted device 300 can be in an off state such that nothing is being displayed.

In some examples, while mounted device 300 is configured to operate in the night mode, mounted device 300 configures at least one sensor to operate and one or more other sensors of mounted device 300 to not operate (e.g., the night mode does not allow the one or more other sensors to detect data). For example, the night mode can allow for a touch sensor (e.g., a touch-sensitive display and/or a physical button) of mounted device 300 to operate but not allow different cameras (e.g., an infrared camera and/or an optical camera) of mounted device 300 to operate. In such an example, mounted device 300 can detect a touch via the touch-sensitive display and/or a press of the physical button but will not be capturing images using a camera.

In some examples, while mounted device 300 is configured to operate in the night mode, mounted device 300 is configured to control a position and/or orientation of mount 310. For example, mounted device 300 can send one or more instructions to mount 310 to lock and/or move mount 310 to a particular location and/or orientation, causing a position and/or orientation of mounted device 300 to be changed. As illustrated in FIG. 3A, mounted device 300 is facing either up or down. It should be recognized that mounted device 330 can be facing another direction in the night mode, such as a wall or other direction away from a user. By facing away from a user, mounted device 300 can provide assurance to users that mounted device 300 is not capturing particular data with respect to the physical environment, such as images via a camera of mounted device 300. In some examples, mounted device 300 is moved to face away from the user when transitioning into the night mode. In other examples, mounted device 300 moves while in the night mode to actively avoid facing the direction of a user.

In some examples, mounted device 300 is placed into the night mode by a user (e.g., user 330). For example, mounted device 300 can enter the night mode in response to user input corresponding to a request to enter the night mode (e.g., detecting a power or lock button of mounted device 300 being pressed, detecting an audio request to transition into the night mode, or detecting selection of a user-interface element to cause the night mode to be entered). In other examples, mounted device 300 is placed into the night mode based on a schedule (e.g., a particular time during the day the mounted device 300 is scheduled by user 330 to be in the night mode). In some examples, mounted device 300 is placed into the night mode after mounted device 300 has not been interacted with for a threshold amount of time or mounted device 300 fails to detect a user in a physical environment. In some examples, mounted device 330 transitions from the day mode into the night mode when the threshold amount of time is reached while in the day mode and/or can transition from the active mode into the night mode when no user is detected in the physical environment.

FIG. 3B is a block diagram illustrating mounted device 300 operating in the night mode with user 330 moving from the location that user 330 was in at FIG. 3A to a different location. As illustrated, mounted device 300 does not move as user 330 moves. In some examples, mounted device 300 is configured to only respond to a particular voice request and/or user input directed to a physical component of mounted device 300, such as a physical button. In such examples, mounted device 300 can transition from the night mode to another mode (e.g., the day mode and/or the active mode) in response to detecting such data via an active sensor, as depicted in FIG. 3C with user 330 reaching to touch mounted device 300. In some examples, the mode that is transitioned to from night mode is based on a gesture detected and/or a configuration of mounted device 300. For example, an unlock gesture (such as through the use of biometric information or a particular gesture) can cause mounted device 300 to transition to active mode while a wake gesture (e.g., a tap or some other gesture not sufficient to unlock mounted device 300) can cause mounted device to transition to a day mode. For another example, mounted device 300 can be configured by user 330 to transition from the night mode to the active mode in response to user input while in the night mode and then transition from the active mode to the day mode based on user input requesting the day mode and/or inactivity while in the active mode.

FIG. 3C is a block diagram illustrating mounted device 300 operating in a day mode. In some examples, the day mode is a mode in which a user (e.g., user 330) is not interacting with mounted device 300 but rather is in the vicinity of mounted device 300. In other examples, user 330 is interacting with mounted device 300 while in the day mode.

As illustrated in FIG. 3C, mounted device 300 is no longer facing up or down (as illustrated in FIGS. 3A-3B) but is now facing user 330. In some examples, transitioning from the night mode to the day mode causes mount 310 to change position and/or orientation such that a position and/or orientation of mounted device 300 is changed to face user 330.

In some examples, the day mode causes mounted device 300 to display limited information, similar to what would be displayed by a lock screen of a phone. Such limited information can include a time, one or more notifications, information from one or more applications executing on mounted device 300, and/or limited functionality to one or more applications executing on mounted device 300 (e.g., access to capture an image but not view images stored on mounted device 300). In some examples, content displayed by mounted device 300 during the day mode is configured to be either landscape or portrait, based on an orientation of mounted device 300. For example, mounted device 300 can be mounted to mount 310 in a portrait orientation (as illustrated in FIG. 3C) and cause display of a user interface (e.g., user interface 350) in the portrait orientation, such as time 352 and weather 354.

In some examples, the day mode configures at least one sensor to operate and one or more other sensors of mounted device 300 to not operate (e.g., the day mode does not allow the one or more other sensors to detect data). For example, the day mode can allow for a touch sensor (e.g., a touch-sensitive display and/or a physical button) and/or an infrared camera of mounted device 300 to operate but not allow an optical camera of mounted device 300 to operate. In such an example, mounted device 300 can detect a touch via the touch-sensitive display, a press of the physical button, and or a user in a physical environment using the infrared camera but will not be capturing images using an optical camera.

In some examples, the day mode causes mounted device 300 to control mount 310 in a way to maintain focus of a display of mounted device 300 in a direction toward user 330, as illustrated in FIGS. 3C-3D with user 330 moving from the left side of mounted device 300 to the right side of mounted device 300. In such examples, mounted device 300 can detect a location of user 330 using the infrared camera and cause mount 310 to move such that mounted device 300 maintains a general direction of user 330. As illustrated in FIG. 3D, mounted device 300 did not turn all the way to the direction of user 330, as it does in FIGS. 3E-3F. Instead, mounted device 300 turned toward user 330 but stopped before turning all of the way to user 330. In some examples, mounted device 300 turns a minimal amount to allow for user 330 to view what is displayed by mounted device 300, such as user interface 350.

FIG. 3E is a block diagram illustrating mounted device 300 operating in an active mode. In some examples, the active mode is a mode in which a user (e.g., user 330) is interacting with mounted device 300. For example, FIG. 3E illustrates mounted device 300 displaying user interface 360, which includes a video call between user 330 and another user. In some examples, mounted device 300 receives frames corresponding to the video call from another device and displays the frames in user interface 360. In such examples, mounted device 300 can also be capturing frame in a field of detection of a camera of mounted device 300, such as a frame of user 330 to send to the other user included in the video call.

It should be recognized that user 330 can be interacting with mounted device 300 in other ways, such as viewing content (e.g., a presentation, a video, an image, and/or text) displayed via mounted device 300. In other examples, user 330 is not interacting with mounted device 300 but instead mounted device 300 is outputting (e.g., displaying or producing audio) for user 330 and is positioned in a particular direction for the outputting. In either set of examples, mounted device 300 can be placed into the active mode by user 330 (e.g., via a gesture, a voice command, and/or a touch on the display screen of device 300) such that user 330 has control of which mode that mounted device 300 is operating.

In some examples, the active mode allows for one or more sensors of mounted device 300 to detect data. For example, the active mode can allow any sensor of mounted device 300 to detect data, including an optical camera of mounted device 300.

In some examples, the active mode allows access to one or more operations of mounted device 300. In such examples, one or more of those operations can be prevented from accessing in other modes (e.g., the night and/or day mode) of mounted device 300. For example, the active mode can allow a user access personal data of mounted device 300 that is not accessible in one or more other modes (e.g., the night and/or day mode) of mounted device 300. For another example, one or more applications of mounted device 300 can be accessible in the active mode and not one or more of the other modes.

In some examples, the active mode causes mounted device 300 to control mount 310 in a way to maintain focus of a display of mounted device 300 in a direction toward user 330, as depicted in FIG. 3F with user 330 moving from the right side of mounted device 300 to the left side of mounted device 300. In such examples, mounted device 300 can detect a location of user 330 and cause mount 310 to move such that mounted device 300 maintains a direction facing user 330.

As mentioned above, FIG. 3F is a block diagram illustrating mounted device 300 operating in the active mode with user 330 moving from the location that user 330 was in at FIG. 3E to a different location. Similar to FIG. 3E, FIG. 3F illustrates user 330 facing mounted device 300 while mounted device 300 is displaying a video call in user interface 360.

FIG. 3F illustrates user input 363 on end affordance 362, which is indicative of user 330 selecting (e.g., via a touch gesture (such as a tap) or other type of user input) end affordance 362 on a display screen of mounted device 300 to end the video call. As used herein, the term “affordance” refers to a user-interactive or selectable graphical user interface object that is, optionally, displayed on a display screen. For example, a selectable image (e.g., icon), button, and text (e.g., hyperlink) each, optionally, constitute an affordance.

User input 363 can cause the video call to end and mounted device 300 to display another user interface or, in some examples, transition to a different mode (e.g., night or day mode, as discussed above).

In some examples, mounted device 300 changes from the active mode to the day mode after a predefined amount of time has passed when mounted device 300 has not detected user 330 (or any user) or after a predefined amount of time has passed since user 330 has last interacted (e.g., touched or otherwise provided input to mounted device 300 to cause an operation to be performed) with mounted device 300.

In some examples, a user selects a default mode in which is used in response to detecting that mounted device 300 is coupled to mount 310. In other examples, mounted device 300 selects a mode most-recently used with mount 310 when reconnecting with mount 310. In other examples, mounted device 300 uses a mode most-recently used with any mount when connecting with mount 310.

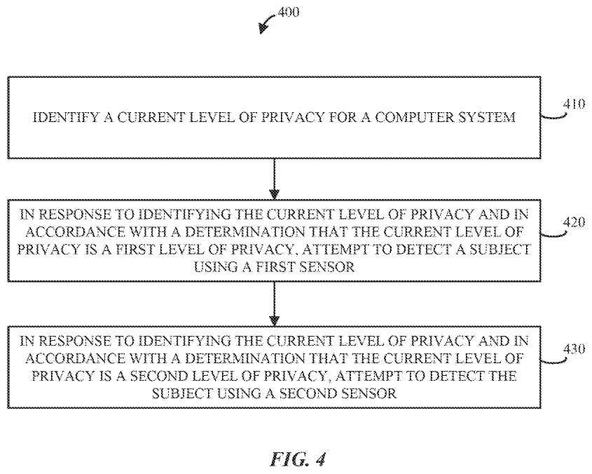

FIG. 4 is a flow diagram illustrating method 400 for detecting data using different sensors. Some operations in method 400 are, optionally, combined, the orders of some operations are, optionally, changed, and some operations are, optionally, omitted. In some examples, method 800 is performed by a compute system (e.g., compute system 100) or a computer system (e.g., computer system 200). In some examples, method 400 is performed by a computer system that is communication with a camera (e.g., an electronic device, such as a user device or an electronic mount); in some examples, the electronic device is coupled (e.g., wired, wirelessly, and/or magnetically) to the user device; in some examples, the computer system includes the camera.

At 410, method 400 includes identifying (e.g., determining) a current level of perception (e.g., low, medium, or high level of perception) for a computer system (e.g., device 300). In some examples, a level of perception refers to a type or amount of data currently being sensed by the computer system. For example, a low level of perception can refer to using a first set of one or more sensors capable of a first fidelity of information about a physical environment, a medium level of perception can refer to using a second set of one or more sensors capable of a second fidelity (e.g., higher than the first fidelity) of information about the physical environment, and a high level of perception can refer to using a third set of one or more sensors capable of a third fidelity (e.g., higher than the second fidelity) of information about the physical environment. In some examples, different sets of sensors include at least one different sensor such that the second set of one or more sensors includes an additional sensor as compared to the first set of one or more sensors and the third set of one or more sensors includes an additional sensor as compared to the second set of one or more sensors. In other examples, different sets of sensors include capturing data at different rates such that the first set of one or more sensors capture data at a first rate, the second set of one or more sensors capture data at a second rate (e.g., more often than the first rate), and the third set of one or more sensors capture data at a third rate (e.g., more often than the second rate).

At 420, method 400 includes, in response to identifying the current level of perception and in accordance with a determination that the current level of perception is a first level of perception, attempting to detect a subject (e.g., a person, a user, an animal, or an object) using a first sensor (and/or detecting the user using the first sensor) (in some examples, the first sensor is a primary or default sensor while the current level of perception is the first level of perception).

At 430, method 400 includes, in response to identifying the current level of perception and in in accordance with a determination that the current level of perception is a second level of perception different from the first level of perception, attempting to detect the subject using a second sensor different from the first sensor (in some examples, the second sensor is a different type of sensor than the first sensor; in some examples, the second sensor is a primary or default sensor while in the second level of perception; in some examples, when the first sensor is used to detect the subject, the second sensor is not used (e.g., or attempted to be used to detect the subject); in some examples, when the second sensor is used to detect the subject, the first sensor is not used (e.g., or attempted to be used); in some examples, while the computer system is configured to operate with the first level of perception and is attempting to detect the subject using the first sensor, the computer system receives a request to operate with the second level of perception; in some examples, in response to receiving the request to operate with the second level of perception, the computer system transitions from attempting to detect the subject using the first sensor to attempting to detect the subject using the second sensor).

In some examples, the first sensor is a touch sensor (e.g., a touch-sensitive display, a physical button, and/or a rotatable input mechanism).

In some examples, the second sensor is an infrared camera (in some examples, the second sensor is a thermographic camera; in some examples, the second sensor is an optical camera (e.g., a camera capturing a plurality of colors) (e.g., telephoto, wide, or ultra-wide angle camera)).

In some examples, method 400 includes, in response to determining the current level of perception: in accordance with a determination that the current level of perception is a third level of perception different from the first level of perception and the second level of perception, attempting to detect the subject using a third sensor different from the first sensor and the second sensor (in some examples, the third sensor is a primary or default sensor while in the third level of perception; in some examples, the third sensor is an optical camera (e.g., an RGB camera, such as a telephoto, wide, or ultra-wide angle camera)).

In some examples, method 400 includes, after detecting the subject using the third sensor, shifting a field of detection of the second sensor to maintain the subject in the field of detection (e.g., a center of the field of detection) as the user moves.

In some examples, method 400 includes: after detecting the subject using the third sensor, displaying a video stream received from a remote device (e.g., that is different from the computer system) (in some examples, more visual content is displayed via the electronic device while in the third level of perception than while in the first level of perception and/or the second level of perception).

In some examples, method 400 includes: after detecting the subject using the second sensor, shifting, in a first manner, a field of detection of the second sensor to maintain the subject in the field of detection of the second sensor as the subject moves relative to the second sensor; and after detecting the subject using the third sensor, shifting, in a second manner different from the first manner, a field of detection of the third sensor to maintain the subject in the field of detection of the third sensor as the subject moves relative to the third sensor, wherein the second manner is a closer follow of the subject than the first manner (e.g., the first manner maintains the subject in a first area of the field of detection and the second manner maintains the subject in a second area of the field of detection, where the second area is smaller than the first area) (in some examples, the second manner includes more movement than the first manner for the user movement).

In some examples, no movement (e.g., no change of a field of detection) occurs when the current level of perception is the first level of perception.

In some examples, method 400 includes: while the current level of perception is the second level of perception, receiving (e.g., via an input device of the electronic device) first user input (e.g., a voice request, a push of a button, or a request to unlock a device (e.g., transition from a locked state to an unlocked state, where one or more additional features are available in the unlocked state compared to the locked state)); in response to receiving the first user input, changing the current level of perception from the second level of perception to the third level of perception; while the current level of perception is the third level of perception, receiving second user input (e.g., a voice request, a push of a button, or a request to lock a device (e.g., transition from an unlocked state to a locked state)); and in response to receiving the second user input, changing the current level of perception from the third level of perception to the second level of perception.

In some examples, attempting to detect the subject using the second sensor includes tracking a position of the subject over time and performing an operation based on a current position of the subject.

In some examples, method 400 includes: in accordance with the determination that the current level of perception is switching to the first level of perception (e.g., currently in a second, third, or fourth level of perception), ensuring (e.g., changing or maintaining) that a direction of one or more sensors (e.g., of the electronic device or of a second electronic device, such as a user device) is maintained in a predefined direction (e.g., up or down).

In some examples, method 400 includes: in response to determining the current level of perception: in accordance with the determination that the current level of perception is the first level of perception, maintaining a display generation component (e.g., of the electronic device or of a second electronic device, such as a user device) in an inactive (e.g., off and/or sleep) state.

In some examples, method 400 includes: after detecting the subject using the second sensor, shifting a field of detection of the second sensor to maintain the subject in the field of detection as the user moves relative to the second sensor (e.g., maintain the field of detection of the second sensor in a direction of the subject).

In some examples, method 400 includes: in response to determining the current level of perception: in accordance with the determination that the current level of perception is the first level of perception, shifting a field of detection of the second sensor (and/or a third sensor) in a direction away from the subject (e.g., the subject is not in the field of the view of the second sensor).

In some examples, method 400 includes: in response to determining the current level of perception: in accordance with the determination that the current level of perception is the second level of perception, displaying an indication of time (in some examples, one or more widgets are displayed with the indication of time when the current level of perception is the second level of perception; in some examples, the second level of perception includes displaying more visual content than the first level of perception and less visual content than the third level of perception).

In some examples, method 400 includes: while the current level of perception is the second level of perception, receiving (e.g., via an input device (e.g., a touch sensor) of the electronic device) first touch input; and in response to receiving the first user input, changing the current level of perception from the first level of perception to the second level of perception.

In some examples, method 400 includes: while the current level of perception is the second level of perception, determining that no user input has been received for a threshold amount of time (e.g., more than zero); and in response to determining that no user input has been received for the threshold amount of time, changing the current level of perception from the second level of perception to the first level of perception.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data may include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services. In another example, users can select not to provide access to particular sensors for data collection or turn off particular sensors (e.g., irrespective of the mode in which the computer system is configured to operate). In yet another example, users can select to not provide precise location information, but permit the transfer of less-precise location information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
identifying a current level of perception for a computer system; and
in response to identifying the current level of perception:
in accordance with a determination that the current level of perception is a first level of perception, attempting to detect a subject using a first sensor; and
in accordance with a determination that the current level of perception is a second level of perception different from the first level of perception, attempting to detect the subject using a second sensor different from the first sensor.

2. The method of claim 1, wherein the first sensor is a touch sensor.

3. The method of claim 1, wherein the second sensor is an infrared camera.

4. The method of claim 1, further comprising:
in response to determining the current level of perception:
in accordance with a determination that the current level of perception is a third level of perception different from the first level of perception and the second level of perception, attempting to detect the subject using a third sensor different from the first sensor and the second sensor.

5. The method of claim 4, further comprising:
after detecting the subject using the third sensor, shifting a field of detection of the second sensor to maintain the subject in the field of detection as the user moves.

6. The method of claim 5, further comprising:
after detecting the subject using the third sensor, displaying a video stream received from a remote device.

7. The method of claim 4, further comprising:
after detecting the subject using the second sensor, shifting, in a first manner, a field of detection of the second sensor to maintain the subject in the field of detection of the second sensor as the subject moves relative to the second sensor; and
after detecting the subject using the third sensor, shifting, in a second manner different from the first manner, a field of detection of the third sensor to maintain the subject in the field of detection of the third sensor as the subject moves relative to the third sensor, wherein the second manner is a closer follow of the subject than the first manner.

8. The method of claim 7, wherein no movement occurs when the current level of perception is the first level of perception.

9. The method of claim 4, further comprising:
while the current level of perception is the second level of perception, receiving first user input;
in response to receiving the first user input, changing the current level of perception from the second level of perception to the third level of perception;
while the current level of perception is the third level of perception, receiving second user input; and
in response to receiving the second user input, changing the current level of perception from the third level of perception to the second level of perception.

10. The method of claim 1, wherein attempting to detect the subject using the second sensor includes tracking a position of the subject over time and performing an operation based on a current position of the subject.

11. The method of claim 1, further comprising:
in accordance with the determination that the current level of perception is switching to the first level of perception, ensuring that a direction of one or more sensors is maintained in a predefined direction.

12. The method of claim 11, further comprising:
in response to determining the current level of perception:
in accordance with the determination that the current level of perception is the first level of perception, maintaining a display generation component in an inactive state.

13. The method of claim 1, further comprising:
after detecting the subject using the second sensor, shifting a field of detection of the second sensor to maintain the subject in the field of detection as the user moves relative to the second sensor.

14. The method of claim 1, further comprising:
in response to determining the current level of perception:
in accordance with the determination that the current level of perception is the first level of perception, shifting a field of detection of the second sensor in a direction away from the subject.

15. The method of claim 1, further comprising:
in response to determining the current level of perception:
in accordance with the determination that the current level of perception is the second level of perception, displaying an indication of time.

16. The method of claim 1, further comprising:
while the current level of perception is the second level of perception, receiving first touch input; and
in response to receiving the first user input, changing the current level of perception from the first level of perception to the second level of perception.

17. The method of claim 1, further comprising:
while the current level of perception is the second level of perception, determining that no user input has been received for a threshold amount of time; and
in response to determining that no user input has been received for the threshold amount of time, changing the current level of perception from the second level of perception to the first level of perception.

18. A non-transitory computer-readable storage medium storing one or more programs configured to be executed by one or more processors of a computer system, the one or more programs including instructions for:
identifying a current level of perception for the computer system; and
in response to identifying the current level of perception:
in accordance with a determination that the current level of perception is a first level of perception, attempting to detect a subject using a first sensor; and
in accordance with a determination that the current level of perception is a second level of perception different from the first level of perception, attempting to detect the subject using a second sensor different from the first sensor.

19. A computer system, comprising:
one or more processors; and
memory storing one or more programs configured to be executed by the one or more processors, the one or more programs including instructions for:
identifying a current level of perception for the computer system; and
in response to identifying the current level of perception:
in accordance with a determination that the current level of perception is a first level of perception, attempting to detect a subject using a first sensor; and
in accordance with a determination that the current level of perception is a second level of perception different from the first level of perception, attempting to detect the subject using a second sensor different from the first sensor.
